(19) United States
(12) Patent Application Publication
(10) Pub. No.: US 2016/0344339 A1
(43) Pub. Date: Nov. 24, 2016

(54) SOLAR CELL MODULE WITH IMPROVED HEAT DISSIPATION CAPABILITY

(71) Applicant: GIXIA GROUP CO., Zhubei (TW)

(72) Inventors: JUNG-YA HSIEH, Hsinchu (TW); SHIH-YUAN LIN, Taipei (TW); YUNG-FU LIN, Hsinchu (TW); YUAN-HSIN CHANG, Hsinchu (TW)

(21) Appl. No.: 15/073,679

(22) Filed: Mar. 18, 2016

Related U.S. Application Data
(60) Provisional application No. 62/162,832, filed on May 18, 2015.

(51) Int. Cl. H02S 40/42; H02S 30/10

(52) U.S. Cl. CPC H02S 40/42; H02S 30/10

(57) ABSTRACT

A solar cell module sequentially comprises a protecting plate, a solar cell structure, and a supporting structure. The supporting structure is filled with a phase change material that can absorb heat to improve the heat dissipation. Thereby, breakage of soldered electric wires of the solar cell structure can be prevented.

### CROSS REFERENCE TO RELATED APPLICATION

This application claims priority from U.S. Provisional Patent Application Ser. No. 62/162,832, filed May 18, 2015.

### FIELD

The subject matter herein generally relates to solar cell module with improved heat dissipation capability.

### BACKGROUND

Solar cell modules are designed to absorb the sun's rays for generating electricity or heating. FIG. 1 is a side view of a solar cell module 100 of prior art. The solar cell module 100 sequentially includes a protecting plate 101, a solar cell structure 102, a back sheet 103, and a supporting structure 104. The supporting structure 104 is made of metal.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a side view of a solar cell module of prior art.

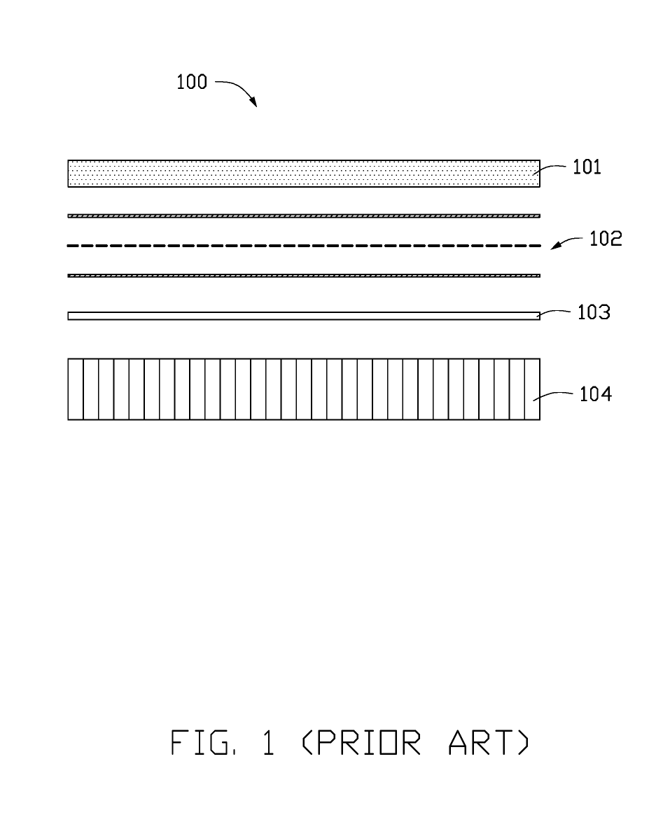

FIG. 2 is a side view of a solar cell module of a first embodiment of the present disclosure.

FIG. 3 is an exploded perspective view of the solar cell module of FIG. 2.

FIG. 4 is an isometric view of a solar cell module of a second embodiment of the present disclosure.

FIG. 5 is a side view of a solar cell module of a third embodiment of the present disclosure.

FIG. 6 is an exploded perspective view of the solar cell module of FIG. 5.

FIG. 7 is an exploded perspective view of a solar cell module of a fourth embodiment of the present disclosure.

FIG. 8 is an exploded perspective view of a solar cell module of a fifth embodiment of the present disclosure.

FIG. 9 is an exploded perspective view of a solar cell module of a sixth embodiment of the present disclosure.

FIG. 10 is a perspective view of supporting structures of solar cell modules of a seventh embodiment of the present disclosure.

FIG. 11 is a side view of a solar cell module of an eighth embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “comprising” means “including, but not necessarily limited to”; it specifically indicates open-ended inclusion or membership in a so-described combination, group, series and the like.

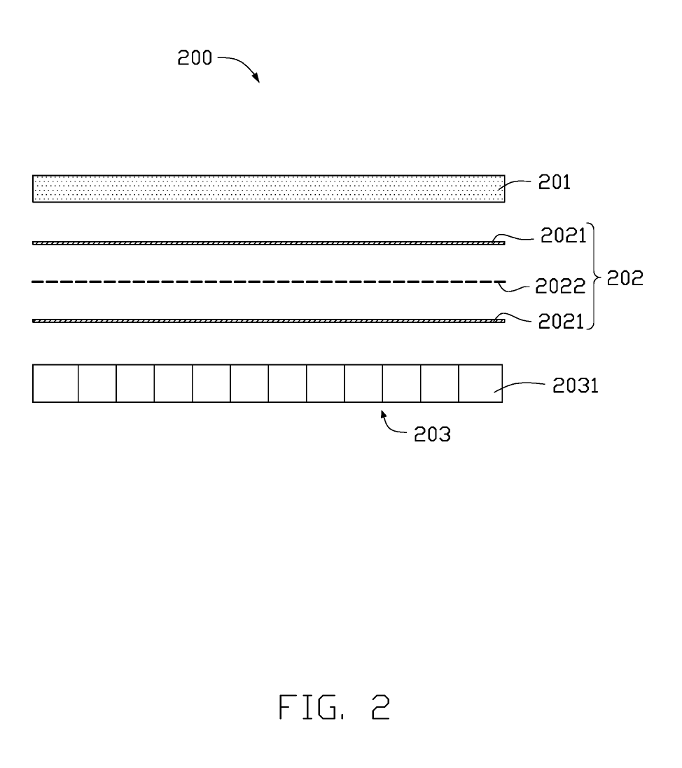

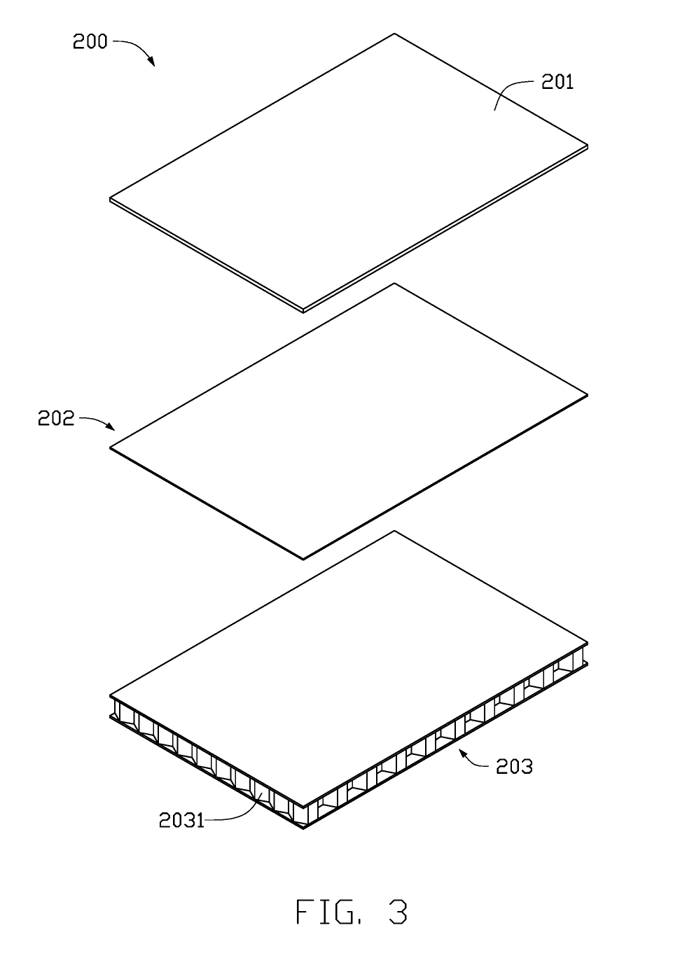

FIG. 2 shows a cross-sectional exploded illustration of a solar cell module 200 in accordance with one embodiment of the present disclosure. FIG. 3 provides an exploded perspective view of the solar cell module 200 of FIG. 2. The solar cell module 200 sequentially comprises a protecting plate 201, a solar cell structure 202, and a supporting structure 203. The protecting plate 201 is a silicone plate, which is a light weight plate with protective properties and can be well used as a protecting plate. In some embodiments, the protecting plate 201 may comprise a polymeric organosilicon compound matieral such as polydimethylsiloxane (PDMS). The solar cell structure 202 has two ethylene-vinyl acetate (EVA) layers 2021 and a cell 2022 between the two EVA layers 2021. The EVA layers 2021 are in the form of sheets. The solar cell structure 202 is conventional and well known, therefore the detail thereof is omitted here. The protecting plate 201 has an outward surface and an inward surface. The outward surface can be coated with an ultraviolet (UV)-resistant film to extend the lifetime of the protecting plate 201. The inward surface can be coated with a cross linking agent or have microstructures formed thereon to improve the adhesion between the EVA layer 2021 and the protecting plate 201. The microstructures can assist in a vacuum suction procedure. The supporting structure 203 comprising a hollow internal portion arranged to substantially accommodate a phase change material which can absorb heat to improve the heat dissipation. Because of the enhanced heat dissipation capability, a solar cell module in accordance with embodiments of the instant disclosure is capable of protecting the soldered portion of the electric wires of the cell 2022 from thermo-related damage. In the first embodiment, the supporting structure 203 has a honeycomb core 2031.

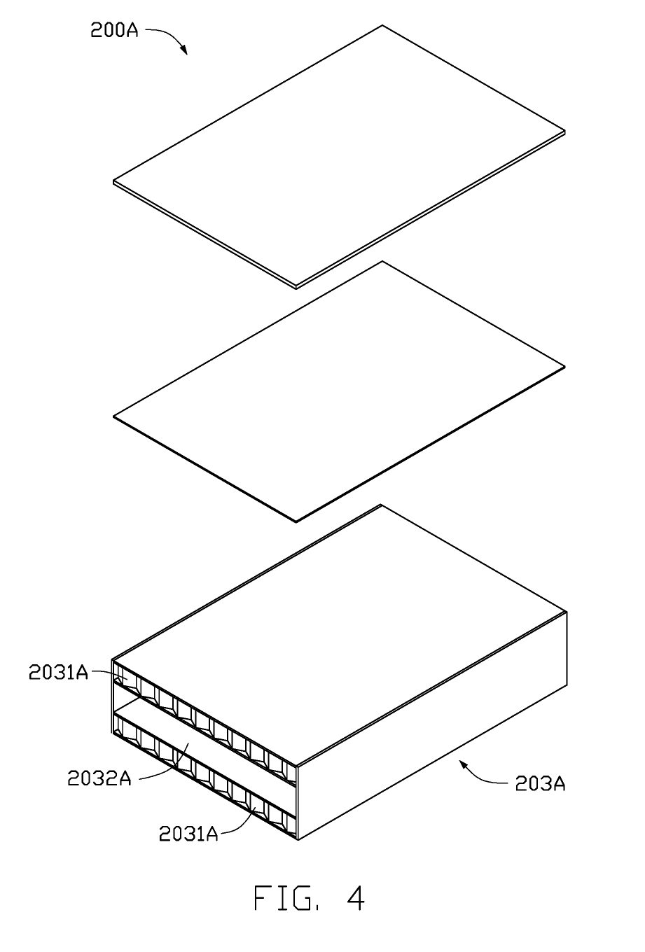

FIG. 4 shows a solar cell module 200A of a second embodiment of the present disclosure. In the second embodiment, the supporting structure 203A has two honeycomb cores 2031A spaced apart. A chamber 2032A is defined between the two honeycomb cores 2031A and prevents heat transfer. The chamber 2032A can securely accommodate a suitable phase change material to improve the heat dissipation.

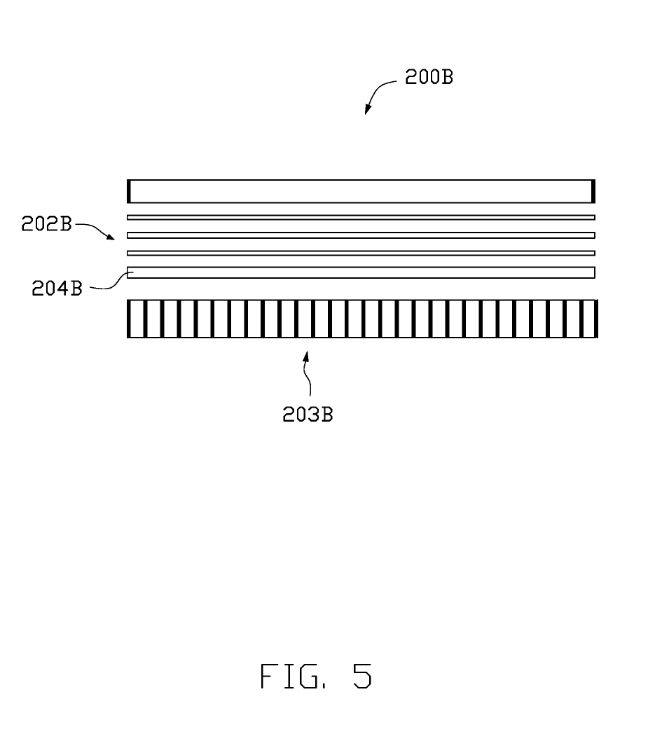

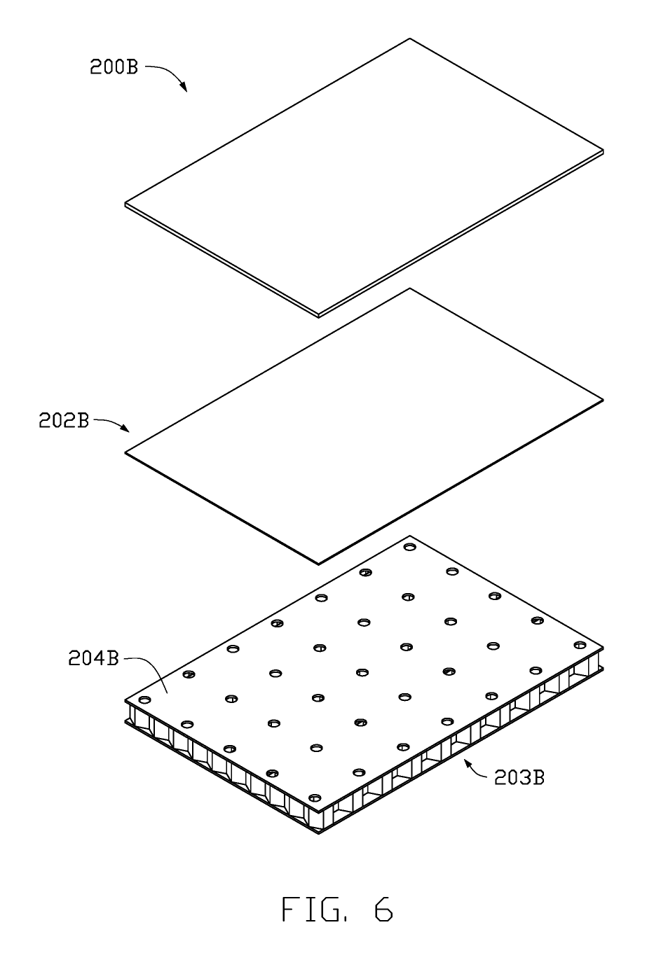

FIG. 5 shows a solar cell module 200B of a third embodiment of the present disclosure. FIG. 6 is an exploded perspective view of the solar cell module 200B of FIG. 5. In the third embodiment, the solar cell module 200B further comprises an aluminum plate 204B which is disposed between the solar cell structure 202B and the supporting structure 203B. The aluminum plate 204B has a plurality of holes therethrough. Thermal expansion of the solar cell module 200B can be neutralized by the structure of the aluminum plate 204B.

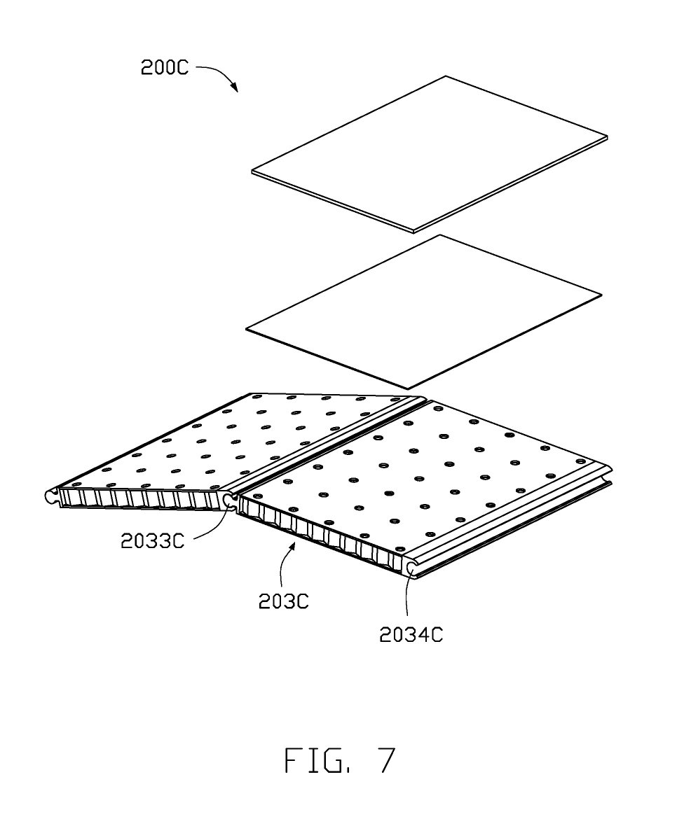

FIG. 7 shows a solar cell module 200C of a fourth embodiment of the present disclosure. In the fourth embodiment, the supporting structure 203C has two opposite sides. An elongated protrusion 2033C extends from one of the sides and an elongated groove 2034C is formed in the other side. The elongated protrusion 2033C of one solar cell module 200C engages the elongated groove 2034C of another solar cell module 200C such that the two solar cell module 200C are pivotally connected. The two solar cell module 200C can be pivoted to adjust an angle therebetween to fit a mounting location such as an architecture roof.

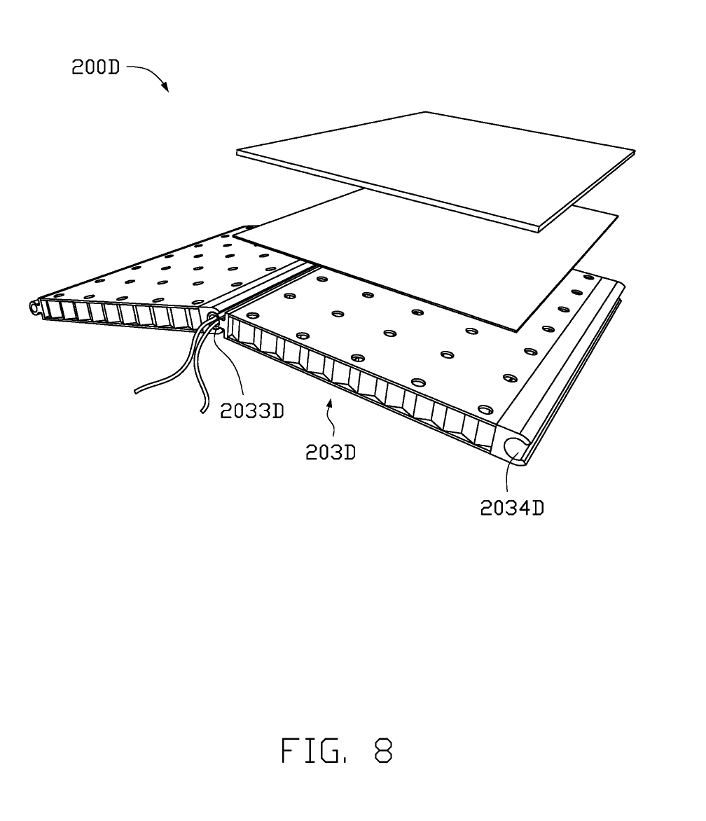

FIG. 8 shows a solar cell module 200D of a fifth embodiment of the present disclosure. In the fifth embodiment, the supporting structure 203D has two opposite sides. An elongated tube 2033D extends from one of the sides and an elongated groove 2034D is formed in the other side. The elongated tube 2033D of one solar cell module 200D engages the elongated groove 2034D of another solar cell module 200D such that the two solar cell module 200D are pivotally connected. The elongated tube 2033D allows wires to pass through.

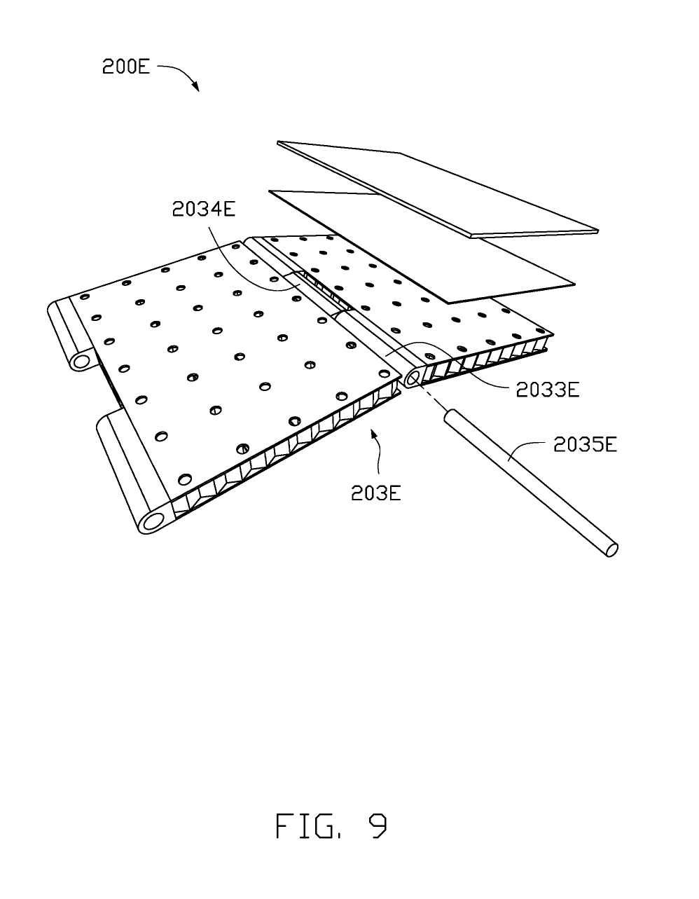

FIG. 9 shows a solar cell module 200E of a sixth embodiment of the present disclosure. In the sixth embodiment, the supporting structure 203E has two opposite sides. Two end protrusions 2033E respectively extends from two end portions of one of the sides and each end protrusion 2033E has a hole therethrough. A middle protrusion 2034E extends from a middle portion of the other side and has a hole therethrough. The middle protrusion 2034E of the one solar cell module 200E is mounted between the two end protrusions 2033E of another solar cell module 200E. The hole of the middle protrusion 2034E of one solar cell module 200E aligns with the holes of the end protrusions 2033E of another solar cell module 200E. A rod 2035E is mounted through the hole of the middle protrusion 2034E of one solar cell module 200E and the holes of the end protrusions 2033E of another solar cell module 200E such that the two solar cell module 200D are pivotally connected.

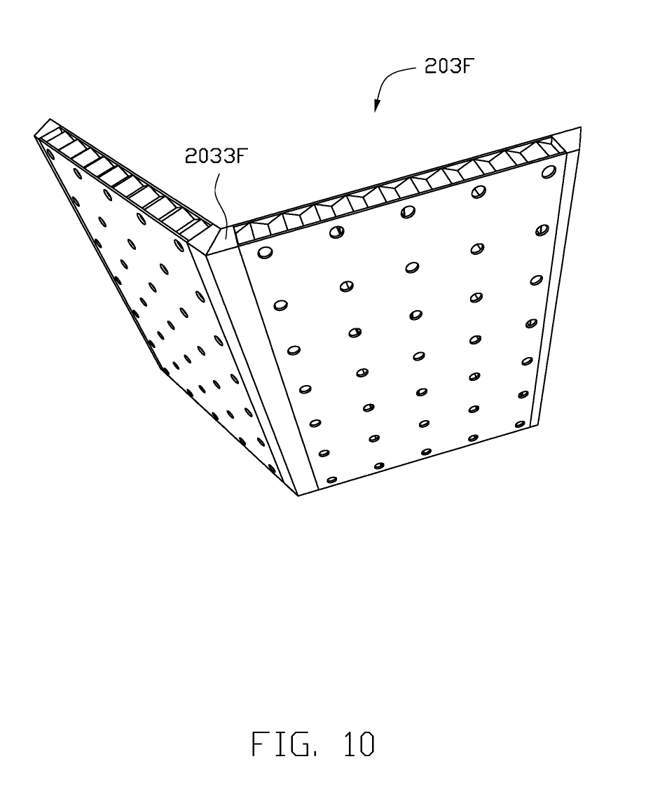

FIG. 10 shows supporting structures 203F of solar cell modules of a seventh embodiment of the present disclosure. In the seventh embodiment, the supporting structure 203F has two opposite sides. Two elongated protrusions 2033F respectively extends from the two sides and each elongated protrusion 2033F has an inclined surface. The inclined surface of the elongated protrusion 2033F of one solar cell module 200F abuts the inclined surface of the elongated protrusion 2033F of another solar cell module 200E such that an angle is formed between the two solar cell modules 200F.

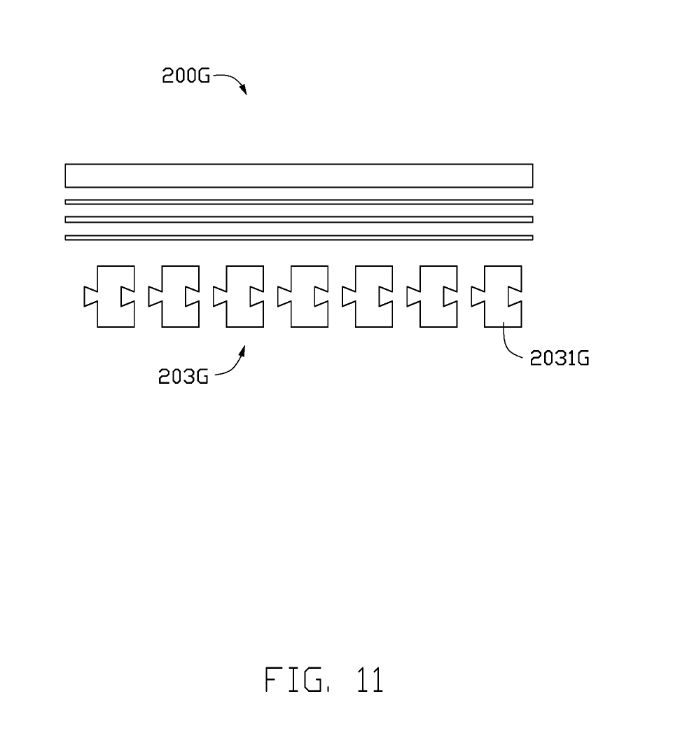

FIG. 11 shows a solar cell module 200G of an eighth embodiment of the present disclosure. In the eighth embodiment, the supporting structure 203G has a combination of aluminum extrusion blocks 2031G. Each extrusion block 2031G has a dovetail for engaging in a mortise in a neighboring extrusion block 2031G. A Gap between each two connected extrusion blocks 2031G can function as a space for absorbing thermal expansion of the combination. Since each block 2031G has a reduced size, it is more easily to be manufactured.

The embodiments shown and described above are only examples. Many details are often found in the art such as the other features of a solar cell module with improved heat dissipation capability. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A solar cell module comprising:
a protecting plate;
a solar cell structure coupled to the protecting plate; and
a supporting structure coupled to the solar cell structure comprising a hollow internal portion arranged to substantially accommodate a phase change material, wherein the protecting plate, the solar cell structure, and supporting structure are sequentially arranged.

2. The solar cell module of the claim 1 further comprising an aluminum plate disposed between the solar cell structure and the supporting structure and having a plurality of through holes defined therein.

3. The solar cell module of the claim 1, wherein the protecting plate comprises substantially silicone material.

4. The solar cell module of the claim 1, wherein the protecting plate comprises substantially a polymeric organosilicon compound matieral.

5. The solar cell module of the claim 1, wherein the protecting plate comprises substantially PDMS.

6. The solar cell module of the claim 1, wherein the supporting structure has a honeycomb core.

7. The solar cell module of the claim 6 further comprising an aluminum plate disposed between the solar cell structure and the supporting structure and having a plurality of through holes defined therein.

8. The solar cell module of the claim 1, wherein the supporting structure has two honeycomb cores spaced apart and a chamber defined there-between.

9. The solar cell module of the claim 8, wherein the chamber accommodates a phase change material.

10. The solar cell module of the claim 8 further comprising an aluminum plate disposed between the solar cell structure and the supporting structure and having a plurality of through holes defined therein.

11. The solar cell module of the claim 1, wherein the supporting structure has two opposite sides, an elongated protrusion extending from one of the sides and an elongated groove formed in the other side.

12. The solar cell module of the claim 1, wherein the supporting structure has two opposite sides, an elongated tube extending from one of the sides and an elongated groove formed in the other side.

13. The solar cell module of the claim 1, wherein the supporting structure has two opposite sides, two end protrusions respectively extending from two end portions of one of the sides and each end protrusion having a hole therethrough, a middle protrusion extending from a middle portion of the other side and having a hole therethrough.

14. The solar cell module of the claim 1, wherein the supporting structure has two opposite sides, two elongated protrusions respectively extending from the two sides and each elongated protrusion having an inclined surface.

15. The solar cell module of the claim 1, wherein the solar cell structure has two EVA layers and a cell between the two EVA layers.

16. The solar cell module of the claim 15, wherein the EVA layers are in the form of sheets.

17. The solar cell module of the claim 1, wherein the protecting plate has an outward surface coated with a UV-resistant film.

18. The solar cell module of the claim 1, wherein the protecting plate has an inward surface coated with a cross linking agent.

19. The solar cell module of the claim 1, wherein the protecting plate has an inward surface formed with microstructures.

20. The solar cell module of the claim 1, wherein the supporting structure has a combination of aluminum extrusion blocks, each extrusion block having a dovetail for engaging in a mortise in a neighboring extrusion block.
